(19) United States
(12) Patent Application Publication
(10) Pub. No.: US 2008/0043248 A1
(43) Pub. Date: Feb. 21, 2008

(54) PHOTONIC CRYSTAL SENSORS USING BAND EDGE AND/OR DEFECT MODE MODULATION

(76) Inventor: Meric Ozcan, Istanbul (TR)

Correspondence Address: VENABLE, CAMPILLO, LOGAN & MEANEY, P.C., 1938 E. OSBORN RD, PHOENIX, AZ, 85016-7234, US

(21) Appl. No.: 11/840,487

(22) Filed: Aug. 17, 2007

Related U.S. Application Data
(60) Provisional application No. 60/822,871, filed on Aug. 18, 2006.

(51) Int. Cl. G01N 21/41

(52) U.S. Cl. 356/517

(57) ABSTRACT

A photonic crystal (PC) based structure is proposed for sensing exceptionally small refractive index changes of a medium. In a typical photonic crystal, the location of the band edges and the defect modes if present are very sensitive to the dielectric contrast of the structure. Hence, a propagating electromagnetic wave at a particular frequency gains significant phase shift due to the index changes and when this phase shift is measured interferometrically, it could be possible to infer the refractive index changes as small as 10⁻¹¹ per lattice distance. Furthermore any other effect that changes the band edge positions (dispersion diagram) of the photonics crystal structure such as binding an analyte to surface of photonic crystal structure will cause detectable phase change in the output wave which will indicate the amount of the analyte. This method can be used to sense biological, biochemical, chemical and refractive index sensing of gases and liquids.

This application claims the benefit of U.S. Provisional Patent Application Ser. No. 60/822,871, filed on Aug. 18, 2006, which is entirely incorporated herein by reference.

### FIELD OF THE INVENTION

The present invention relates to the field of sensing. Particularly, it involves the field of refractive index sensing, pressure sensing, biological, chemical, and biochemical sensing using photonic crystal sensors. More particularly, the invention may be used to detect of very small refractive index changes by measuring the phase shift of a propagating electromagnetic wave in photonic crystal sensors structure caused by an interaction with variable (pressure, chemical moiety, etc.) of interest.

### BACKGROUND

Many interesting uses of photonic crystals have been suggested and demonstrated, such as yielding lower radiation losses, routing the light in the integrated optics applications and enhancement of the radiation due to the intentionally created defects in the periodicity of the photonic crystals. See J. C. Knight, J. Broeng, T. A. Birks, and P. St. Russel, Science 282, 1476 (1998); Solomon Assefa, Peter T. Rakich, Peter Bienstman, Steven G. Johnson, Gale S. Petrich, John D. Joannopoulos, Leslie A. Kolodziejski, Erich P. Ippen, and Henry I. Smith, Appl. Phys. Lett. 85, 6110 (2004); Steven G. Johnson, Christina Manolatou, Shanhui Fan, Pierre R. Villeneuve, and J. D. Joannopoulos, Opt. Lett. 23, 1855 (1998); and O. Painter, R. K. Lee, A. Scherer, A. Yariv, J. D. O'Brien, P. D. Dapkus, and I. Kim, Science 284, 1819 (1999). The defects created when the crystal terminates perturb the ideal photonic band gaps of the crystal, and cause an allowed mode in the band gap with a relatively narrow frequency spread which is used to create laser cavities with high quality factors See Steven G. Johnson, Shanhui Fan, Attila Mekis, and J. D. Joannopoulos, Appl. Phys. Lett. 78, 3388 (2001) and Tomoyuki Yoshie, Jelena Vuckovic, Axel Scherer, Hao Chen, and Dennis Deppe, Appl. Phys. Lett. 79, 4289 (2001).

For example, a generic (not a photonic crystal of this invention) interferometric sensor configuration which is called Mach-Zehnder interferometer is shown in FIG. 1 Here an optical waveguide is formed on a substrate and the incoming light is split into two arms. Top arm-labeled as sensing arm—will be exposed to the measurand. The lower arm-labeled as the reference arm serves as the reference. Both arms later combined and the resultant output signal is applied to a detector (in the case of light as the input wave this is a photodetector). The detected signal is analyzed by the signal processing unit (electronically in analog or digital fashion or after digitizing the output signal, signal processing can be done in software by a computer. The output signal of this simple interferometer will be proportional to the cosine (or sine) of the phase difference between the arms of the interferometer. More specifically if the phase difference between the arms is ΔΦ, the output intensity Io will be in the form of Io=Iin (1+M cos ΔΦ), where M is the modulation factor and Iin is the input light intensity. The phase difference will be caused by the external perturbance such as pressure, refractive index change of the waveguide or by change of binding external material to the waveguide in the sensing arm. This kind of interferometers and interferometric sensors are built using optical fibers as well as in integrated optics. Integrated optic Mach-Zehnder interferometric sensors utilizing planar geometry have been used in glucose sensing (REF: Liu, Y., Hering, P., and Scully, M. O., “An Integrated Optical Sensor for Measuring Glucose Concentration”, Appl. Phys. B, Photophys. Laser Chem. B54, 18-23 (1992)), in immunosensing (REF: Brecht, A., Ingenhoff, J. and Gauglitz, G., “Direct Monitoring of Antigen-Antibody Interactions by Spectral Interferometry”, Sensors and Actuators, B6, 96-100(1992)), and for pesticide determination (Schipper, E. F., Kooyman, P. H., Heideman, R. G., and Greve, J. , “Feasibility of Optical Waveguide Immunosensors for Pesticide Detection: Physical Aspects”, Sensors and Actuators B24/25, 90-93 (1995)) etc. In the simple interferometer above, the output signal is not a linear function of the phase difference (a common method of demodulation is homodyne detection). Several methods were developed to overcome difficulties associated with this nonlinearity (such as fading in the output signal, noise, sensitivity loss, drift in the gain of the system etc). For example one can modulate the phase in one or both of the interferometer arms by an external electrical signal source (usually a periodic signal which could be called carrier signal) so that the output signal—phase difference between the arms of the interferometer—will be a phase or frequency modulated around the carrier frequency (heterodyne method) instead of simple sine or cosine form. See Özcan, M. “Fiber Optic Vibration Sensor and its Application to Structural Control”, SPIE Proceedings, Vol. 2270, 48-55, July 1994.) Afterwards the signal processing unit will demodulate the output signal to recover the phase difference between the arms. Additional information on these signal processing and signal recovery methods are known in the art and are so additional detailed information is omitted.

Therefore, photonic crystals have recently attracted considerable attention in sensor applications as well. There are chemical detectors and bio sensors reported in the literature based on photonic crystal configurations which work on the principle of measuring the changes in the dielectric contrast. In such sensors, index modulation is detected by sensing the shift of the emission wavelength of photonic crystal lasers. See X. Wang, K. Kempa, Z. F. Ren, and B. Kimball, Appl. Phys. Lett. 84, 1817 (2004); Jesper B. Jensen, Lars H. Pedersen, Poul E. Hoiby, Lars B. Nielsen, T. P. Hansen, J. R. Folkenberg, J. Riishede, Danny Noordegraaf, Kristian Nielsen, A. Carlsen, and A. Bjarklev, Opt. Lett. 29, 1974 (2004) and Marko Loncar, Axel Scherer, and Yueming Qiu, Appl. Phys. Lett. 82, 4648 (2003). Also it has been shown that nonlinear optical properties of the photonic crystals can be employed to modify the band formations for optical switching applications. Alain Hache and Martin Bourgeois, Appl. Phys. Lett. 77, 4089 (2000); and Xiaoyong Hu, Yuanhao Liu, Jie Tian, Bingying Cheng, and Daozhong Zhang, Appl. Phys. Lett. 86, 121102 (2005).

There is one reported photonic crystal based chemical or biochemical sensor in which a polystyrene spheres (diameters of 100 nm) polymerized within a hydrogel that swells and shrinks reversibly in the presence of certain analytes such as metal ions or glucose. The hydrogel contains a molecular recognition group that either binds or reacts selectively with an analyte, The result of the recognition process is a swelling of the gel which in turn leads to a change in the periodicity of the photonic crystal structure. In turn this change is recorded as the changes on the diffracted wavelength of the light See J. H. Holtz, S. A. Asher, Nature 389, 829-832 (1997).

Photonic crystals (PCs) are periodic structures, which modify the dispersion relation of an electromagnetic (EM) wave. In an analogy to that of electrons in a crystal, EM waves at certain frequencies are prohibited from propagation. In essence, forbidden bands are formed at specific frequency intervals which are determined by the dimensions and the dielectric constants of the PCs. The present invention discloses a method for the detection of a very small refractive index change by measuring the phase shift of a propagating EM wave in PC structure. As explained below, band diagrams are a strong function of the dielectric contrast and a slight change index induces a large phase shift on the propagating wave.

Some disadvantages of currently known photonic crystal sensors include their poor sensitivity, poor response time and noise due to the fact they are sensing the changes in amplitude in general.

Currently available refractive index sensors based on the waveguide topologies have sensitivities on the order of 10⁻⁵. See Romeo Bernini, Stefania Campopiano, Charles de Boer, Pasqualina M. Sarro, and Luigi Zeni, IEEE Sensors Journal 3, 652 (2003) and G. J. Veldhuis, L. E. W. van der Veen, and P. V. Lambeck, J. of Lightwave Technol. 17, 857 (1999). However, with the invented method can reach down to sensitivities of 10⁻¹³.

### SUMMARY

It is an object of the present invention to provide a photonic crystal sensor and related method comprising a photonic crystal sensor comprising: a photonic crystal lattice having band gap range; a electromagnetic generator to produce electromagnetic waves having an operating frequency within the band gap range; a electromagnetic detector to receive the electromagnetic waves after they have passed through the photonic crystal lattice; and an analyzer to compare the received electromagnetic waves to the generated waves.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a diagrammatic view of a configuration of one embodiment of an interferometric sensor.

FIG. 2 is a diagrammatic view of a preferred embodiment an optical waveguide (which could be the sensing arm) coated with a binding agent (FIG. 2a) and the binding agent interacting with whatever the binding agent is designed to attract (FIG. 2b); such as particles, chemicals, bio-agents, enzymes, etc.

FIG. 3 is a graph showing the calculated lowest two band of a square lattice of dielectric rods standing in air with a lattice constant of a. ε_{rods}=13.39, r_{rods}=0.2a.

FIG. 4 is a graph showing the calculated phase shift estimation of an EM wave at band edge 1 with a frequency of ω₀.

FIG. 5 is a diagrammatic view of a preferred embodiment an experimental setup for sensor characterizations for the invention.

FIG. 6 is a graph showing testing data for transmission characteristic of the photonic crystal structure of a preferred embodiment of the invention.

FIG. 7a is a theoretically calculated and experimentally measured phase shift values at the band edges (a) Phase shifts at X band edge, f=8 GHz of the preferred embodiment of the invention.

FIG. 7b is a theoretically calculated and experimentally measured phase shift values at the band edges (b) Phase shifts at M band edge, f=9.3 GHz of the preferred embodiment of one of the invention.

FIG. 8 is a diagrammatic view of a preferred embodiment a two dimensional photonic crystal (PC) waveguides for a PC interferometer.

FIG. 9 is a diagrammatic view of a preferred embodiment a two dimensional photonic crystal (PC) interferometer sensor.

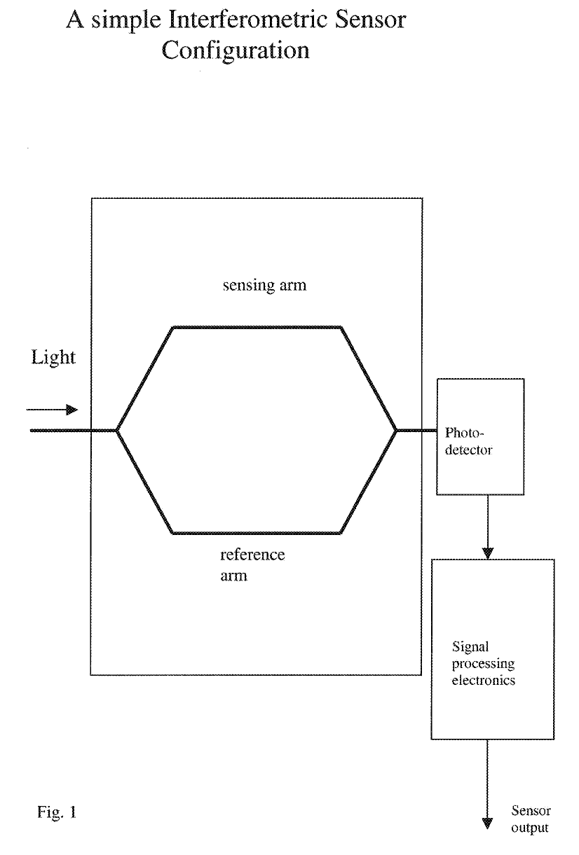

### DESCRIPTION OF PREFERRED EMBODIMENTS

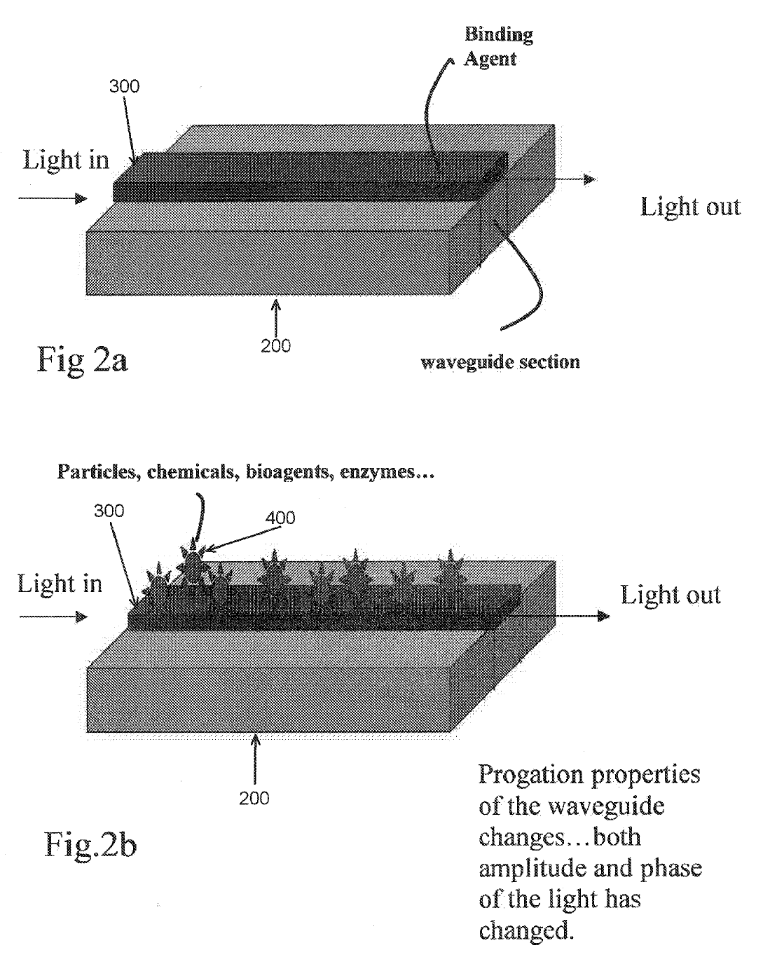

The photonic crystal device of this invention relates to the deviations in the dielectric constants of the photonic crystal (PC) alter the band diagrams of the structure so that the sensitivity of the sensor can be understood in terms of the dynamically revised dispersion relations and thereby the phase shifts of the traveling EM (electromagnetic) wave specifically at the band edges. When the above said PC is located in one arm of an interferometer and the resultant phase shift of the wave is measured, it will indicate the amount of the perturbance. As shown below, a PC that is designed to operate at microwave frequencies and the change in the dielectric contrast was provided by change of the background pressure hence a sensor operation as a refractive index sensor or pressure sensor. However, the present invention may be a PC that is constructed in similar fashion as a part of an interferometer it can be used to sense the presence and the amount of various biological, chemical, biochemical components, enyzmies, various DNA reactions etc. Such a PC structure PC may be placed in a liquid or gas medium which may then be used to measure the refractive index changes of the liquid or gas medium (also referred herein as the “atmosphere”). In one embodiment, FIG. 2a shows an example of an optical waveguide 200 (which could be the sensing arm) coated with a binding agent 300, and FIG. 2b shows some particles, chemical, bio-agents, enzymes (whatever the coating is designed to attract) 400 are attached to the agent. The resultant phase change is recorded when this output light is combined with the light coming from the reference arm (which is not affected at all).

The scalability of Maxwell's equations allows the examination the EM waves in a broader spectrum and the modes in the PCs can be solved independent of the lattice constants. Then the invention may be demonstrated at longer wavelengths proving the concept of the invention. Since the governing equations of the PC is Maxwell'e Equations the whole PC structure can be can be scaled down (miniaturized) to operate at light wavelengths (infrared through visible range for example). Such small structures can be built in one dimensional and two dimensional forms over a substrate (3 dimensional structures are also built but they are much more difficult to manufacture) using electron beam lithography or similar methods.

It has been shown that Photonic Crystal based beam splitters, channel add drop filters function at microwave regime without the loss of generality. See Mehmet Bayindir, B. Temelkuran, and E. Ozbay, Appl. Phys. Lett. 77, 3902 (2000) and Mehmet Bayindir and Ekmel Ozbay, Optics Express 10, 1279 (2002). While the specific example of the invention demonstrated herein relates to the microwave regime it is scalable to other electromagnetic sources. All of the results are applicable, and convertible to the optical wavelengths with appropriate materials and by appropriate scaling. For example, the photonic crystal sensors may be created using high intensity x-rays, or photolithographically by use of coherent and/or non-coherent ultraviolet, visible light or other electromagnetic sources.

The specific embodiment described herein of the PC based sensor operates in the GHz frequencies and requires the construction of a square lattice crystal having a certain dielectric contrast with respect to the background index. Two antennas and an interferometer configuration are needed to analyze the scattered propagation of the EM waves. The modeling and design of the sensor together with the experimental setup are explained in detail below.

Theoretical Analysis

Maxwell's electromagnetic theory can be outlined with two primary equations which constitute the theoretical fundamentals for a propagating wave in a PC.

$$\frac{1}{ɛ ( r )} ▽ \times \{ ▽ \times E ( r ) \} = {( \frac{ω}{c} )}^{2} E ( r ) \\ ▽ \times \frac{1}{ɛ ( r )} \{ ▽ \times H ( r ) \} = {( \frac{ω}{c} )}^{2} H ( r ) \qquad ( 1 )$$

These are the eigenvalue equations for electric and magnetic fields respectively. Furthermore, since the media is periodic the dielectric function and the field vectors satisfy the Bloch theorem which enables us to express them in terms of series expansions:

$$\frac{1}{ɛ ( r + a )} = \frac{1}{ɛ ( r )} = {\sum }_{G} κ ( G ) exp ( i G \cdot r ) \\ {E}_{k} ( r , t ) = {u}_{k} ( r ) {e}^{i k \cdot r} = {\sum }_{G} {E}_{k} ( G ) exp ( i ( k + G ) \cdot r - i ω t ) \\ {H}_{k} ( r , t ) = {u}_{k} ( r ) {e}^{i k \cdot r} = {\sum }_{G} {H}_{k} ( G ) exp ( i ( k + G ) \cdot r - i ω t ) \qquad ( 2 )$$

The symbol G represents the reciprocal lattice vector and a is the lattice constant. Hence, the eigenvalue equations can be transformed into the following coupled matrix form combining Eq. (1) and Eq. (2) for a two dimensional TM polarized electric field. K. Sakoda, Optical Properties of Photonic Crystals (Springer, Berlin, 2001).

$${\sum }_{G} {M}_{k} ( G , {G}^{′} ) {E}_{k} ( {G}^{′} ) = {( \frac{ω}{c} )}^{2} {E}_{k} ( G ) \qquad ( 3 )$$

Thus the eigenvalues of the matrix Mₖ(G,G′) are the eigenfrequencies (ω) of the propagating wave. This method is known as the Plane Wave Expansion Method (PWEM) and employed PWEM has been as a handy tool to visualize the band diagrams for 2-D periodic arrangements. Despite the several shortcomings of the approach, PWEM can be summarized as a flexible and easily adaptable methodology for numerous different situations. The errors coming from PWEM can be minimized by increasing the plane wave numbers up to a sufficient high number. See Linfang Shen and Sailing He, J. Opt. Soc. Am. A 19, 1021 (2002) and H. S. Sözüer, J. W. Haus, and R. Inguva, Phys. Rev. B 45, 13962 (1992).

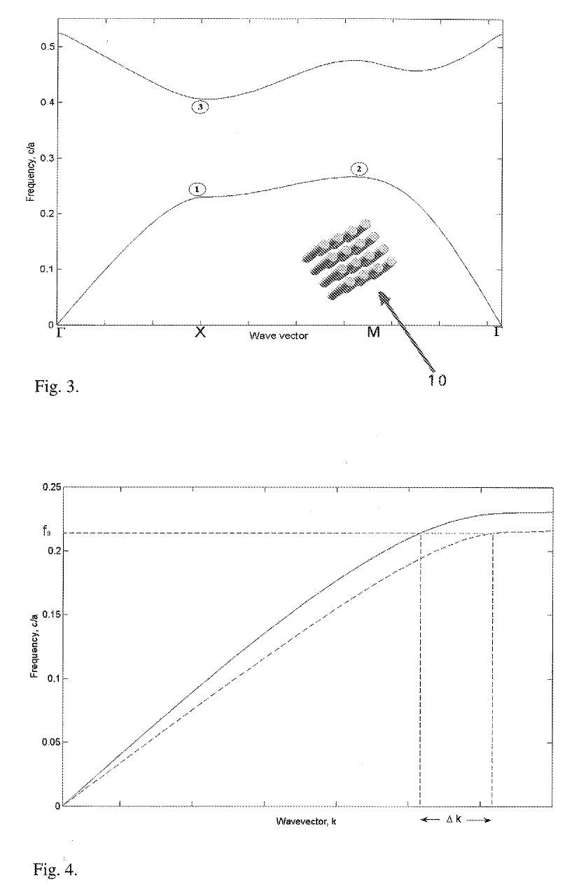

As an example, the lowest two bands for a preferred square lattice of rods 10 with a lattice constant a and a rod diameter of d=0.4a were calculated. The dispersion diagram is plotted in FIG. 3 where the points Γ, X, M are the traditional representations for the corners of the irreducible Brillouin zone of the square lattice. Each rod stands in air and has a dielectric constant of ε_{rods}=13.39. The slopes at the three designated band edges are small enough to practically study the phase shifts. It should be noted that the lattice is generally of any regularly repeating geometry (e.g. square, hexagonal, triangular etc.) and any type of geometric crystal (e.g. rods, bars, cubes, cylinders, spheres etc.) Furthermore the lattice of the photonic crystal structure could be one dimensional, two dimensional, as shown in FIG. 3, or they could be built as 3 dimensional structures. In most configurations they are arranged in regular, in an orderly fashion like a triangular array, square array, hexagonal array etc. However one can design the structure of the photonic crystal structure in a complicated order to have a specific band edge and/or defect mode characteristics.

When the background dielectric constant, which is air for this example, is perturbed, band diagrams move such that an EM wave traveling with a certain frequency and a wavevector is going to encounter a phase shift. If the transmission at that particular frequency is investigated, the amount of phase shift, ΔΦ is directly proportional to Δk. The phase shifts at the first band edge can graphically be seen in FIG. 4 which illustrates the band edge modulation at the first edge for the PC configuration whose band diagram shown in FIG. 3. The dispersion relations have been solved in the Γ-X direction as the background index is incremented (dashed line) from its initial value (solid line). At a specific frequency, ω₀, the EM wave will have a phase shift that can be defined as, ΔΦ=Δk.L where L represents the optical path traveled by the EM wave.

Following the same methodology, the relevant phase shifts at the three band edges were estimated separately. The evaluations have been computed for index modulations starting with 10⁻⁵ down to 10⁻¹⁰. The calculated phase shifts pursue almost a linear response on the logarithmic scale with respect to the index modulations such that for a 10⁻¹⁰ refractive index change produces 10⁻⁷ radians per lattice phase shift. Considering that 10⁻⁸ radians phase shifts in 1 Hz bandwidth can be detectable interferometrically, it can be deduced that 100 lattice long PC sensor can detect as small as 10⁻¹³ changes in the refractive index. See J. Hwang, M. M. Fejer, and W. E. Moerner, Proc. SPIE, 4962, 110, (2003).

When the performance characteristics at distinct band edges is compared, it is apparent that better results can be attained by working at edge (point 3 in the FIG. 4). Upper band is influenced at higher rates from index modulations, which causes larger phase shifts at the output. Likewise, similar arguments can be done for PC with defects. Modest defect bands, created by the removal of one dielectric rod would also produce phase shifts. The defect mode based PCs are promising candidates for sensor applications since the calculations show that the sensitivity of the sensor can be further improved down to 10⁻¹⁴ with simple defect formations and using the frequencies near the defect mode.

Experimental Results

As a preferred proof of the invention, experiments were conducted in the in the microwave regime with a PC made up of a 7×7 (49) matrix of alumina (generally of the chemical formula Al₂O₃) rods obtained from Anderman Ceramics of United Kingdom. The simulations had been carried out for 2-D structures and therefore the length of the constructed PC has been chosen to be long enough to sustain homogeneity in the third dimension. The main operating frequency has been selected as 10 GHz, which corresponds to a wavelength of λ=3 cm. At this stage, it was predicted that a length of (4-5)λ would be sufficient to minimize the scattering in the third dimension. A square lattice configuration has been achieved by arranging 15 cm long alumina rods properly with a lattice constant of 1 cm. Alumina is a good microwave material with low tangent losses and a relatively high dielectric constant of 9.79. The radius of the rods were 0.2 cm which would produce a band gap approximately between 7.91-13.04 GHz in the Γ-X direction and 9.25-15.96 GHz in the X-M direction.

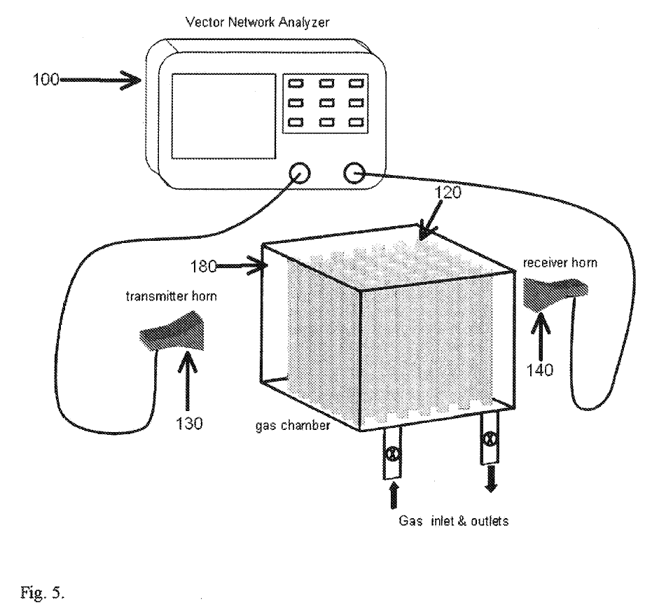

FIG. 5 shows the experimental setup 100. A electromagnetic generator 110 (a S-parameter Vector Network Analyzer (Agilent 8720ES)) has been used to generate the electromagnetic waves propagating through the photonic crystal lattice 120 located inside an enclosure 180 (also called the gas chamber in this embodiment). In this preferred embodiment the electromagnetic waves are emitted from the transmitter horn 130 passing through the photonic crystal lattice 120 contained in enclosure 180 such that the atmosphere contacting the photonic crystal lattice 120 may be controlled (e.g. a plexiglass gas chamber in this preferred embodiment ) and received by the receiver horn 140 (also sometimes called a detector). While for purposes of this preferred example, a gas chamber is used as the enclosure, in other preferred embodiments it is possible to use a liquid enclosure or no enclosure at all.

Data analysis of the received signals has also been realized with the Network Analyzer (Agilent 8720ES) 110 by recording the amplitude and the phase of the received signal. More specifically, the Network Analyzer has an embedded interferometer that can measure the phase differences of the received signal with respect to the transmitted signal which is used for recording the phase of the microwave at the edge of the first photonic band gap as the gas pressure is changed. In this preferred embodiment, the transmitter horn 130 and receiver horn 140 antennas have been designed with center frequencies at 10 GHz. The antennas exhibited a flat transmission (flat S₂₁) and high radiation (low S₁₁) around the two lowest frequency bands of the photonic crystal lattice 120, which have been vital for the experiments. In this preferred embodiment, the antennas have been strictly aligned to face each other on the same horizontal line. The aperture and the beam size of the antennas were comparably smaller than the dimensions of the photonic crystal lattice 120 to allow most of the field to be coupled into the photonic crystal lattice 120 and thereby preventing the diffracted fields to be detected by the receiver horn due to the finite size of the photonic crystal lattice 120.

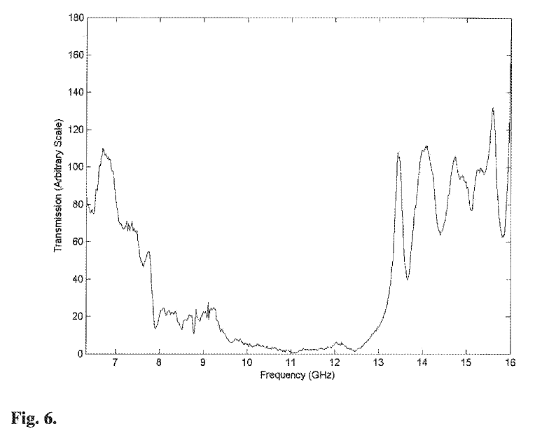

In order to cancel the Fabry Perot contributions from the walls of the plexiglass gas chamber, the transmission characteristics of the photonic crystal lattice 120 has been studied in air. The free space transmission of the antennas had been recorded initially which is used later as the background subtraction, and then the transmission values through the photonic crystal lattice 120 structure is recorded. FIG. 6 below illustrates the transmission of the photonic crystal lattice 120 after the background subtraction. The transmission characteristics show the band edges of the photonic crystal lattice 120 clearly.

In agreement with the theoretical expectations, the band edges turned out to lie roughly at 8 GHz and 13 GHz. Yet, there is still some amount of transmission up to 9.3 GHz owing to the diffraction of the waves in the X-M direction.

As a demonstration of the photonic crystal lattice 120 sensor, a pressure sensor, MPX2202DP (manufactured by Motorola, Inc. USA) had been attached to the gas chamber while a nitrogen tank has been utilized to stabilize the pressure in the chamber. At higher radio frequencies, the refractive index of nitrogen gas is assumed to vary almost linearly with changing pressure (P) according to the following equation. See L. Essen, Proc. Phys. Soc. B 66, 189 (1953) and K. D. Froome, Proc. Phys. Soc. B 68, 833 (1955).

(n_{nitrogen}−1)×10⁶=294.1×P (4)

### The gas chamber could stand up to 1.5 atm pressure at which the refractive index of nitrogen would change by 10⁻⁴ at most.

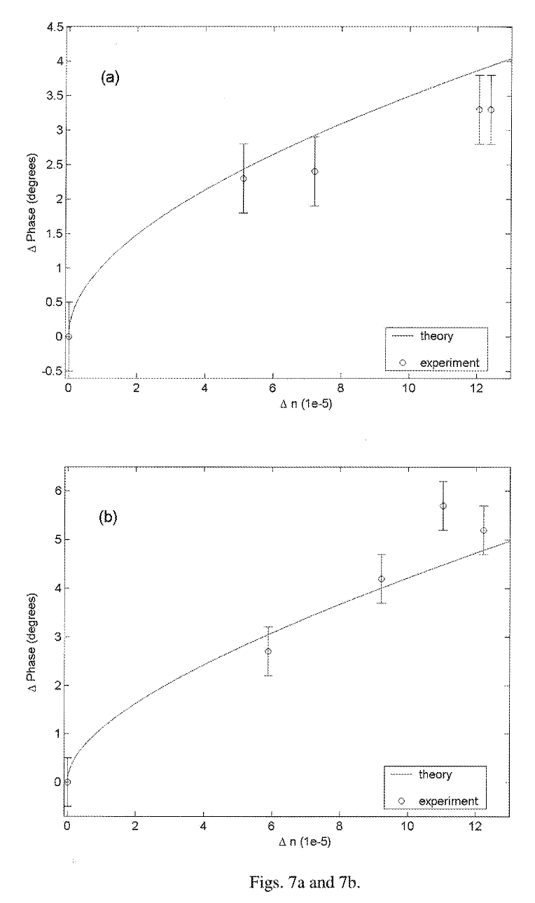

FIGS. 7a and 7b below show the phase shift values produced by the band edge modulations. The experimental values are in good agreement with the theoretical results. The error bars represent one degree of fluctuations in measurements. At the microwave regime, it is possible to easily detect refractive index changes of 6×10⁻⁵. The larger phase shifts at band M can be explained by smaller slope values of the band diagram at that specific edge.

The possible phase change if photonic crystal lattice 120 were not present in the chamber was calculated to resolve that the primary changes were caused by the band edge modulations. As the gas pressure was modified, an L=12 cm long chamber would also yield a phase difference in proportional to the expression given in Eq. (5).

$$Δ Φ = \frac{2 π}{λ} Δ {n}_{nitrogen} L \qquad ( 5 )$$

However, even a rather large index change of Δn_{nitrogen}=10⁻⁴, would produce a phase change of only 0.14 degrees, which is 25 times less than what was obtained in the experiments. Therefore, the modulation at the photonic band edges is dominantly responsible for phase shifts obtained. Also it is important to point out that, a waveguide structure with the same length as the photonic crystal lattice 120 structure, experiencing the same amount of index modulations in its claddings would at most cause a phase shift of 0.1 degrees, which again signifies the importance of the method.

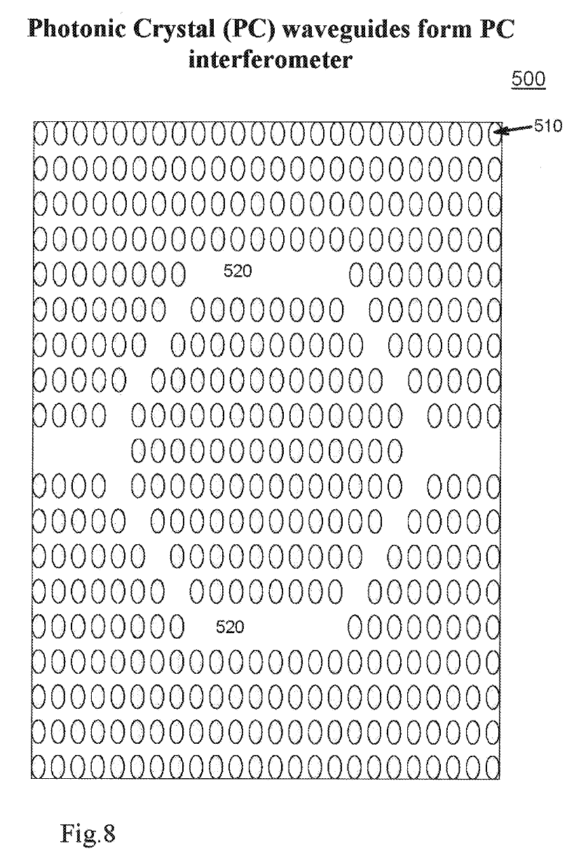

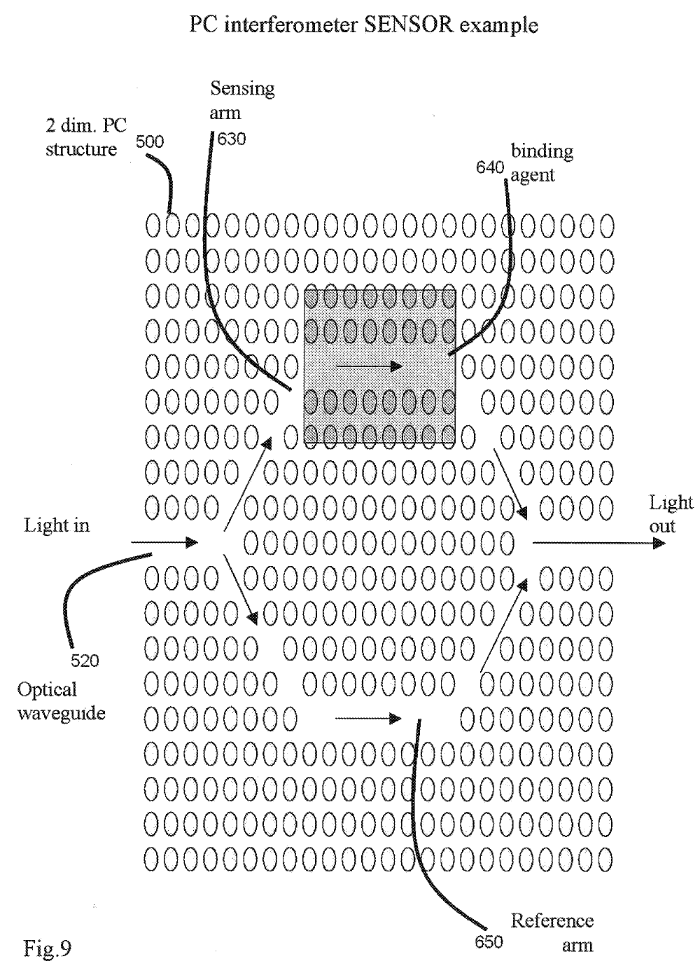

In another preferred embodiment of the invention, when an interferometric sensor is formed with a photonic crystal structure and when it is operated at an appropriate frequency (or wavelength) near the band edge or the defect mode it will operate at much higher sensitivity, In one preferred embodiment, FIG. 8 shows a generic photonic crystal (PC) based waveguide structure 500 similar to PC structures. In this preferred embodiment, a square array of circular shaped elements 510 which could be rods erected on a substrate. When the elements are removed as shown in FIG. 8, a waveguide 520 is formed. In yet another preferred embodiment of the invention, FIG. 9 shows a generic photonic crystal based interferometric sensor configuration where one arm is used as the sensing arm 630 coated with an analyte (binding agent) 640 and the other arm is the reference arm 650. Operating frequencies may range from microwave frequencies to ultraviolet since the photonic crystal structures are scalable (operating frequency can be extended even shorter wavelength such as X-rays if one can arrange atomic size structures to form a photonic crystal). The above interferometric sensor configurations can be modified to include an external modulator applied to one or both of the arms to enhance the performance of the phase demodulation but that is just a signal processing method as explained above. These additional modifications do not affect the main idea of photonic crystal based interferometric sensor invention presented here over ordinary interferometric sensors.

Examples of the uses of the inventions include:

1. A photonic crystal structure can be used as a sensor by measuring the changes in the phase of the electromagnetic wave interferometrically. If there is any change in the parameters of the photonic crystal structure due to some external perturbance and when the frequency of the wave (or the wavelength) is near the band edge or at the defect mode (defect mode is created when the periodicity of the photonic crystal is disturbed intentionally), the changes in the phase is largest. By monitoring the phase changes one can deduce the amount of perturbance. For example, tuning the generated frequency to work in the band edge frequency of a photonic crystal structure allows a large phase shift due to nonlinearity of the dispersion curve (an example is shown in FIG. 4). More specifically, as shown in FIG. 4, dispersion curves flattens near the band edge, hence for a slight change in the medium parameters produce a large change in the wave vector Δk (meaning a larger phase change of the wave) than otherwise possible if the propagation medium was homogenous (dispersion curves are straight lines for a homogenous medium). In one preferred example, this kind of nonlinearity can be obtained with Bragg grating written optical fibers (which is an example of one dimensional photonic crystal structure). More preferably, one can built sensors using commercially available photonic crystal optical fibers (for example, Thorlabs Inc, USA) using principle outlined in this invention.

2. This method can be used to monitor refractive index changes of a gaseous, a liquid or a solid medium. If the background of the PC structure is a gas medium it can also be used as a sensitive pressure sensor.

3. This device can be used as a biological, biochemical and/or chemical sensor. When a biological specimen is applied to the dielectric of the PC structure—assuming the dielectric is absorbing the specimen—it modifies the refractive index of the PC structure. The resultant phase change due to this index change gives information about the amount of the biological material.

4. Photonic crystal structure can be formed in a slab shape such that it can be covered on one side with some biorecognition elements such as enzymes, antibodies, and microorganisms having a highly specifity for binding the analyte of interest. When there is binding of the analyte on the surfaceover the biorecognition elements, band structure of the photonic crystal is affected similar to background index change. When an appropriate electromagnetic wave is applied to the photonic crystal structure (at the band edges and/or at the defect mode frequency) and the resultant phase change is recorded one can deduce the amount of analyte. Most sensitive method of recording the phase changes is in interferometer configuration where the electromagnetic wave is split into two arms, one arm goes through the sensor structure and the other arm serves as a reference. After the wave goes trough the sensor section it is combined with the wave that leaves the reference arm. The resultant wave is sent to a detector (to a photodetector in the case of a light wave).

5. This sensor will work at any frequency or wavelength when appropriately scaled since the operation of the system is fundamentally governed by Maxwell Equations. Therefore this method can be applied for sensor applications from microwave frequencies to the light waves.

6. The devices can be applied for chemical analyte sensing as well with similar configuration as explained in item [041] above.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A photonic crystal sensor comprising:
a photonic crystal lattice having band gap range;
a electromagnetic generator to produce electromagnetic waves having an operating frequency within the band gap range;
a electromagnetic detector to receive the electromagnetic waves after they have passed through the photonic crystal lattice; and
an analyzer to compare the received electromagnetic waves to the generated waves.

2. The sensor of claim 1 wherein photonic crystal lattice surface further comprises binding agents selected from the group consisting of complementary chemical agents, enzymes, antibodies, microorganisms and combinations thereof.

3. The sensor of claim 1 wherein the periodicity of the photonic lattice is a regularly repeating one, two, or three dimensional geometry or a complicated order to have a specific band edge and/or defect model characteristics.

4. The sensor of claim 1 wherein the periodicity of the photonic lattice is selected from square, hexagonal and rectangular, triangular or other orderly geometric configurations.

5. The sensor of claim 1 wherein the photonic crystal sensor detects pressure, chemical agents, and biological agents.

6. The sensor of claim 1 wherein the electromagnetic waves are X-ray, ultraviolet, visible, infrared or microwave wavelengths.

7. The sensor of claim 6 wherein the electromagnetic waves are coherent and/or are relatively narrow bandwidth.

8. The sensor of claim 1 wherein the band gap comprises at least one band gap edge and the electromagnetic generator is tuned to produce electromagnetic waves having an operating frequency near the at least one of the band gap edge to increase sensitivity.

9. The sensor of claim 1 wherein the analyzer is an interferometer.

10. A method of detection comprising measuring a band gap having a band edge frequency of a photonic crystal lattice comprising the steps of: generating electromagnetic waves having an operating frequency; passing the generated electromagnetic waves through an atmosphere containing a photonic crystal lattice having a band gap range containing the operating frequency; receiving the passed electromagnetic waves on a detector; and comparing the generated electromagnetic waves to the received electromagnetic waves to determine changes in the band gap and/or at the band edge frequency of the photonic crystal lattice due to changes in the atmosphere.

11. The method of claim 10 further comprising the step of: tuning the operating frequency to near the band edge frequency to increase the sensitivity.

12. The method of claim 11 wherein the step of tuning the operating frequency to near the band edge frequency to increase the sensitivity comprises using passing the generated electromagnetic waves through a Bragg grating written optical fibers.

13. An interferometer sensor comprising
a photonic crystal lattice having band gap range and forming at least a reference arm waveguide and a sensing arm waveguide;
a electromagnetic generator to produce electromagnetic waves having an operating frequency within band gap range;
a electromagnetic detector to receive the electromagnetic waves after they have passed through the photonic crystal lattice; and an analyzer to compare the received electromagnetic waves of the sensing arm waveguide to the reference arm waveguide.

14. The sensor of claim 13 wherein photonic crystal lattice surface further comprises binding agents selected from the group consisting of complementary chemical agents, enzymes, antibodies, microorganisms and combinations thereof.

15. The sensor of claim 13 wherein the periodicity of the photonic lattice is a regularly repeating one, two,or three dimensional geometry or a complicated order to have a specific band edge and/or defect model characteristics.

16. The sensor of claim 13 wherein the periodicity of the photonic lattice is selected from square, hexagonal and rectangular, triangular, or other orderly configurations configurations.

17. The sensor of claim 13 wherein the photonic crystal sensor detects pressure, chemical agents, and biological agents.

18. The sensor of claim 13 wherein the electromagnetic waves are X-Ray, ultraviolet, visible, infrared or microwave wavelengths.

19. The sensor of claim 13 wherein the electromagnetic waves are relatively narrow bandwidth and/or are coherent.

20. The sensor of claim 13 wherein the band gap comprises at least one band gap edge and the electromagnetic generator is tuned to produce electromagnetic waves having an operating frequency near the at least one of the band gap edge to increase sensitivity.
